(19) United States
(12) Patent Application Publication
(10) Pub. No.: US 2025/0391275 A1
(43) Pub. Date: Dec. 25, 2025

(54) SHIP UNLOADER ANTI-COLLISION SYSTEM BASED ON PLC CONTROL

(71) Applicant: HUANENG POWER INTERNATIONAL, INC. SHANGHAI SHIDONGKOU FIRST POWER PLANT, Shanghai (CN)

(72) Inventors: Kun Zhou, Shanghai (CN); Junjie Di, Shanghai (CN); Baozhong Tian, Shanghai (CN); Yongyan Chen, Shanghai (CN); Jialei Deng, Shanghai (CN); Jiyuan Liu, Shanghai (CN); Jiawei Wu, Shanghai (CN); Yijie Zhang, Shanghai (CN); Shaonan Chen, Shanghai (CN)

(73) Assignee: HUANENG POWER INTERNATIONAL, INC. SHANGHAI SHIDONGKOU FIRST POWER PLANT, Shanghai (CN)

(21) Appl. No.: 19/243,708

(22) Filed: Jun. 20, 2025

(30) Foreign Application Priority Data
Jun. 20, 2024 (CN) 202410797960.9

(51) Int. Cl. G08G 3/02; B65G 67/60

(52) U.S. Cl. CPC G08G 3/02; B65G 67/60; B65G 2203/044; B65G 2814/0397

(57) ABSTRACT

The present invention relates to a ship unloader anti-collision system based on PLC control, including: a plurality of photoelectric limit sensors, evenly spaced in a terminal area to divide the terminal area into a plurality of zones; an absolute encoder installed on a carriage part of a ship unloader to collect a forward distance of carriage traveling wheels; a reflector installed on a hull to trigger the photoelectric limit sensors; and a control unit configured to determine an alarm zone requiring anti-collision according to incoming ship information in the terminal area; and during movement of the ship unloader, receive the limit signals transmitted by each photoelectric limit sensor, calibrate the distance information generated by the absolute encoder, determine a position of the ship unloader, and real-time judge whether the position of the ship unloader reaches the alarm zone, and generate a collision alarm signal if reaching the alarm zone.

### CROSS-REFERENCE TO RELATED APPLICATION

This application claims the priority benefit of China application serial no. 202410797960.9, filed on Jun. 20, 2024. The entirety of the above-mentioned patent application is hereby incorporated by reference herein and made a part of this specification.

### TECHNICAL FIELD

The present invention relates to the technical field of ship unloader anti-collision, and particular to a ship unloader anti-collision system based on PLC control.

### BACKGROUND

As key equipment of large-scale machinery at a cargo terminal, a ship unloader needs to frequently move forward and backward during coal unloading. It is prone to collisions with a ship radar and a tower crane under a high tide and poor operational visibility. During operation, it completely relies on the experience of a driver of the ship unloader and on-site observation. In a case of a collision, it may mildly affect economic efficiency of a unit (e.g., ship and port machinery maintenance costs, ship demurrage fees, etc.), or severely causing a casualty. This issue has long troubled terminal operators with operational equipment. Domestic terminals often deploy automotive radars on port machinery as anti-collision systems (in forms such as infrared or laser). However, in practical applications, discrepancies in installation positions arise due to varying deployment points and ship types. Additionally, this arrangement is inconvenient for calibration and maintenance, and is prone to malfunction or false actions under adverse weather conditions.

### SUMMARY

The purpose of the present invention is to overcome the deficiencies in the prior art, wherein automotive radars deployed on port machinery as anti-collision systems are inconvenient for calibration and maintenance, and are prone to malfunction or false actions due to weather conditions. To address these issues, the present invention provides a ship unloader anti-collision system based on PLC control.

The purpose of the present invention can be realized by the following technical schemes:

A ship unloader anti-collision system based on PLC control, comprising:
a plurality of photoelectric limit sensors, evenly spaced in a terminal area to divide the terminal area into a plurality of zones;
an absolute encoder installed on a carriage part of a ship unloader to collect a forward distance of carriage traveling wheels;
a reflector installed on a hull to cooperate with the photoelectric limit sensors and trigger limit signals of the photoelectric limit sensors; and
a control unit connected to each photoelectric limit sensor and absolute encoder to determine an alarm zone requiring anti-collision according to incoming ship information in the terminal area; during movement of the ship unloader, receive the limit signals transmitted by each photoelectric limit sensor, calibrate the distance information generated by the absolute encoder, determine a position of the ship unloader, and real-time judge whether the position of the ship unloader reaches the alarm zone, and generate a collision alarm signal if reaching the alarm zone.

Further, a process that the control unit calibrates the distance information generated by the absolute value encoder is specifically as follows:
when an Nth photoelectric limit sensor is triggered to generate the limit signal, i.e., entering an Nth zone, reading the forward distance information generated by the absolute encoder; during continuous movement of the ship unloader, judging whether the read forward distance information is less than n times spacing of the photoelectric limit sensors; if so, judging whether the limit signal generated by triggering a (N+1)th photoelectric limit sensor is received; if received, resetting a value of the absolute encoder to zero and determining a distance of the Nth zone as the spacing between the two photoelectric limit sensors; if the read forward distance information is greater than n times the spacing of the photoelectric limit sensors, judging that the (N+1)th photoelectric limit sensor is damaged, generating a damage alarm signal, and defaulting that the (N+1)th photoelectric limit sensor has been triggered and the distance of the Nth zone is the spacing between the two photoelectric limit sensors until the distance detected by the absolute encoder between two adjacent photoelectric limit sensors is less than n times the spacing of the photoelectric limit sensors, and then resetting the value of the absolute encoder to zero.

Further, a value of n is 1.5.

Further, the control unit determines the position of the ship unloader according to the value of the absolute encoder and the zone where the absolute encoder locates, thereby judging whether the position of the ship unloader has reached the alarm zone.

Further, when a working region of the ship unloader overlaps with the alarm zone, the control unit issues an alarm signal for an anti-collision zone.

Further, the control unit also obtains data from a tide gauge to dynamically adjust the alarm zone requiring anti-collision.

Further, the alarm zone requiring anti-collision is determined according to a distance between an antenna of an incoming ship in the terminal area and a driver cabin of the ship unloader.

Further, during the movement of the ship unloader, the control unit judges whether a photoelectric limit sensor at a corresponding position senses the reflector according to the forward distance transmitted by the absolute encoder and the limit signal from the photoelectric limit sensor, and if the reflector is sensed, the carriage is displayed to be within a normal operating interval; and if the reflector is not sensed, the carriage is judged to enter an alarm interval, and a signal to stop the movement of the carriage is output at the moment.

Further, the reflector corresponds to a horizontal height of each photoelectric limit sensor and is located in the middle of the hull of the ship unloader.

Further, the control unit is a PLC controller.

### DESCRIPTION OF THE DRAWINGS

FIG. 1 is a schematic diagram showing an arrangement of photoelectric limit sensors in a ship unloader anti-collision system based on PLC control provided in an embodiment of the present invention;

FIG. 2 is a schematic diagram showing an anti-collision process in the ship unloader anti-collision system based on PLC control provided in an embodiment of the present invention; and

FIG. 3 is a schematic diagram showing a position relationship between a ship unloader and a ship provided in an embodiment of the present invention.

In the drawings: 1. beam; 2. trolley; 3. driver cabin; 4. grab bucket; 5. machine room; 6. ship reflector plate.

### DETAILED DESCRIPTION OF THE PREFERRED EMBODIMENTS

In order to make the purposes, technical schemes, and advantages of the embodiments of the present invention clearer, the technical schemes in the embodiments of the present invention will be described clearly and completely below in conjunction with accompanying drawings. Apparently, the embodiments described are some embodiments of the present invention, but not all embodiments. Components described and illustrated in the embodiments of the present invention in the accompanying drawings can be arranged and designed in various configurations.

Therefore, the detailed description of the embodiments of the present invention provided in the accompanying drawings is not intended to limit the scope of the claimed invention but merely represents selected embodiments of the present invention. Based on the embodiments in the present invention, all other embodiments obtained by those skilled in the art without making creative labor fall within the protection scope of the present invention.

It should be noted that similar reference numerals and letters in the following drawings indicate similar items. Once an item is defined in one drawing, it does not need to be further defined and explained in subsequent drawings.

In the description of the present invention, it should be noted that orientations or positional relationships indicated by terms “center”, “upper”, “lower”, “left”, “right”, “vertical”, “horizontal”, “inside”, “outside”, etc. are based on orientations or positional relationships shown in the accompanying drawings or conventional orientations or positional relationships when the product of the present invention is used. These terms are merely for convenience in describing the present invention and simplifying the description, and do not indicate or imply that the referred devices or elements must have specific orientations, be constructed in specific orientations, or operate in specific orientations. Therefore, they should not be understood as limitations to the present invention.

### Embodiment 1

A ship unloader anti-collision system based on PLC control provided in this embodiment, comprising:
a plurality of photoelectric limit sensors, evenly spaced in a terminal area to divide the terminal area into a plurality of zones;
an absolute encoder installed on a carriage part of a ship unloader to collect a forward distance of carriage traveling wheels;
a reflector installed on a hull to cooperate with the photoelectric limit sensors and trigger limit signals of the photoelectric limit sensors; and
a control unit connected to each photoelectric limit sensor and absolute encoder to determine an alarm zone requiring anti-collision according to incoming ship information in the terminal area; during movement of the ship unloader, receive the limit signals transmitted by each photoelectric limit sensor, calibrate the distance information generated by the absolute encoder, determine a position of the ship unloader, and real-time judge whether the position of the ship unloader reaches the alarm zone, and generate a collision alarm signal if reaching the alarm zone.

Correspondingly, this scheme arranges a plurality of photoelectric limit sensors at the cargo terminal to divide the terminal area, with one sensor installed every X meters. According to the layout of the photoelectric limit sensors, the coal unloading terminal is divided into N zones. The output signals of each photoelectric limit sensor are connected to the control unit.

When the carriage of the ship unloader approaches the boundary of the zone during operation, it is regarded as an alarm zone. An absolute encoder is additionally installed at the carriage position of each ship unloader, and connected to the control unit via analog signals, etc., for accurately identifying the position of the ship unloader. By combining the encoder and limit sensors, automatic calibration of the encoder can be achieved, reducing workload of maintenance personnel.

Optionally, a process that the control unit calibrates the distance information generated by the absolute value encoder is specifically as follows:
when an Nth photoelectric limit sensor is triggered to generate the limit signal, i.e., entering an Nth zone, reading the forward distance information generated by the absolute encoder; during continuous movement of the ship unloader, judging whether the read forward distance information is less than n times spacing of the photoelectric limit sensors; if so, judging whether the limit signal generated by triggering a (N+1)th photoelectric limit sensor is received; if received, resetting a value of the absolute encoder to zero and determining a distance of the Nth zone as the spacing between the two photoelectric limit sensors; if the read forward distance information is greater than n times the spacing of the photoelectric limit sensors, judging that the (N+1)th photoelectric limit sensor is damaged, generating a damage alarm signal, and defaulting that the (N+1)th photoelectric limit sensor has been triggered and the distance of the Nth zone is the spacing between the two photoelectric limit sensors until the distance detected by the absolute encoder between two adjacent photoelectric limit sensors is less than n times the spacing of the photoelectric limit sensors, and then resetting the value of the absolute encoder to zero.

Optionally, a value of n is 1.5.

Optionally, the control unit determines the position of the ship unloader according to the value of the absolute encoder and the zone where the absolute encoder locates, thereby judging whether the position of the ship unloader has reached the alarm zone; and
when a working region of the ship unloader overlaps with the alarm zone, the control unit issues an alarm signal for an anti-collision zone.

The alarm zone requiring anti-collision is determined according to a distance between an antenna of an incoming ship in the terminal area and a driver cabin of the ship unloader. As the antenna of the ship is also affected by the tide level and ship draft, on one hand, the control unit obtains data from the tide gauge to dynamically adjust the alarm zone requiring anti-collision; on the other hand, in this scheme, the reflector is installed on the hull, and when the photoelectric limit sensor is activated, it is displayed to be within the normal operating interval, and when the photoelectric limit sensor does not sense the reflector, it is considered to be within the alarm interval. At this point, a signal to stop the movement of the carriage is output, prohibiting the carriage from entering the alarm zone to prevent collisions with cargo ships.

That is, during the movement of the ship unloader, the control unit judges whether a photoelectric limit sensor at a corresponding position senses the reflector according to the forward distance transmitted by the absolute encoder and the limit signal from the photoelectric limit sensor, and if the reflector is sensed, the carriage is displayed to be within a normal operating interval; and if the reflector is not sensed, the carriage is judged to enter an alarm interval, and a signal to stop the movement of the carriage is output at the moment.

The reflector corresponds to a horizontal height of each photoelectric limit sensor and is located in the middle of the hull of the ship unloader.

In the following, a specific implementation example of the above scheme using a PLC as the control unit is introduced.

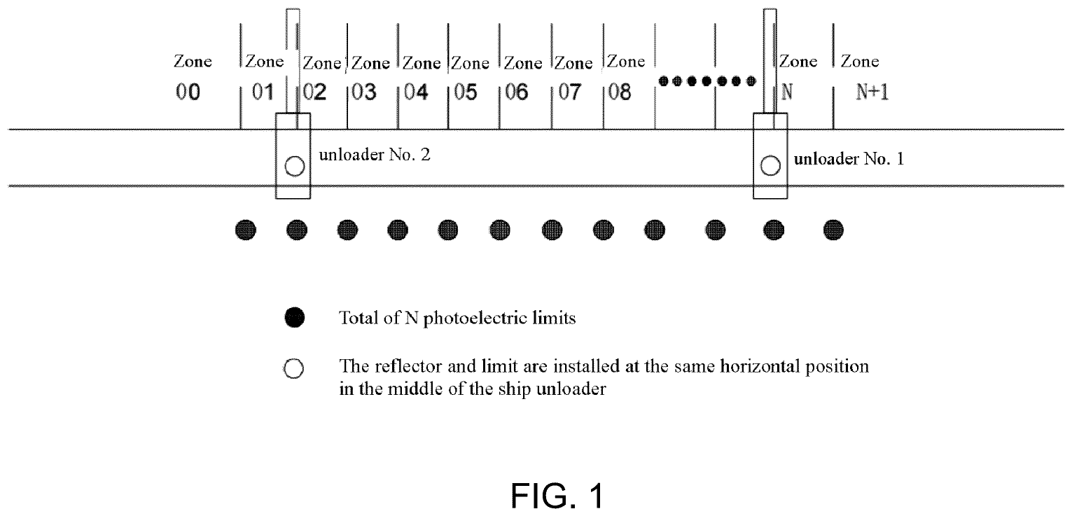

As shown in FIG. 1, N photoelectric limit sensors are installed at the terminal of the ship unloader, dividing the terminal area into N+1 zones, with one sensor arranged every X meters. Using a PLC as the control unit, input signals comprise photoelectric limit signals (N signals), forward and backward signals for two ship unloaders (2 pairs, totaling 4 signals), etc. Output signals comprise anti-collision operation region alarm signals, limit fault signals, etc. Additionally, each ship unloader has a light-emitting plate installed at its middle position to trigger the photoelectric limit sensors. An absolute encoder is additionally installed at the carriage position of each ship unloader, which is connected to the PLC via analog signals, etc. for accurately identify the position of the ship unloader.

Each photoelectric limit sensor needs to meet zone judgment requirements for the two carriages in both directions. By coordinating the photoelectric limit sensors with the forward and backward signals of the carriage, precise judgment of the working region is achieved. Photoelectric signals in dynamic states are similar to pulse signals. Since one limit sensor needs to meet the requirements of the two carriages, there may be errors in zone selection. In cases where two zones overlap, a ship unloader No. 2 is considered as a larger zone, while a ship unloader No. 1 is considered as a smaller zone. By connecting normally open contacts in parallel combined with normally closed connections of corresponding zones, correct judgment of different zones can be achieved.

The photoelectric limit sensors and absolute encoders are connected to the PLC system of the ship unloader to achieve automatic calibration of the limit function. Due to potential slipping phenomenon between the carriage traveling wheels and the tracks, the actual distance traveled by the absolute encoder between two limit sensors may exceed X meters.

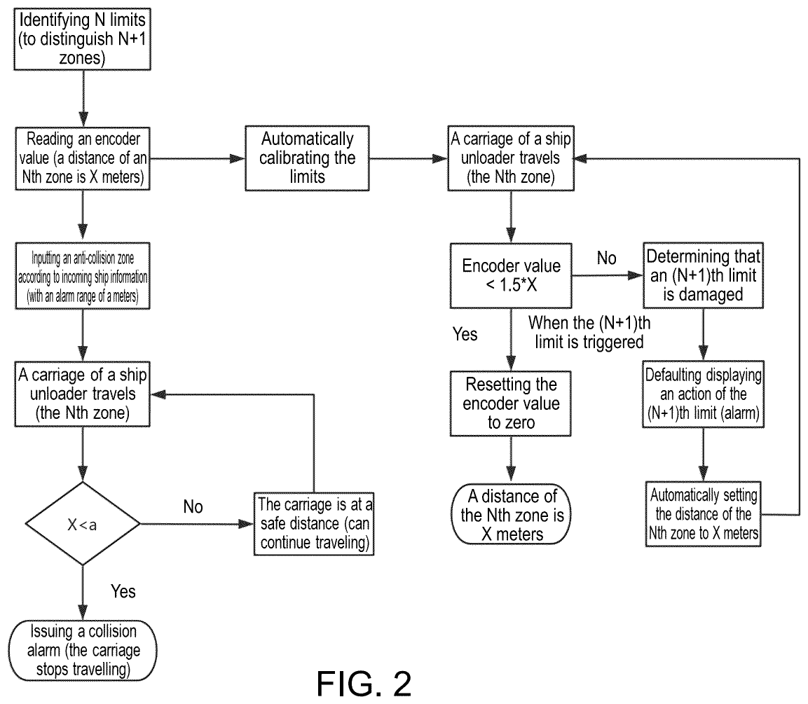

As shown in FIG. 2, when the carriage moves from an Nth limit to an (N+1)th limit, if the encoder value is less than 1.5*X meters when the limit is triggered, the encoder value is reset to zero and movement continues. If the carriage moves from the Nth limit to the (N+1)th limit, the encoder value is reset to zero when an (N+1)th photoelectric limit switch is triggered. If the encoder value exceeds 1.5*X meters before the limit is triggered, an (N+1)th limit sensor is potentially damaged. In this case, the system assumes the (N+1)th limit sensor has been activated, issues an alarm, and automatically sets the distance between the Nth limit and the (N+1)th limit to X meters until the actual encoder distance between the two limits is less than 1.5*X meters, at which point it is reset to zero again.

Based on incoming ship information, the alarm range for the anti-collision zone is pre-input as a meters. When the ship unloader enters the alarm zone, the PLC issues a stop moving command to the carriage and configures to issue an alarm. The alarm signals on the ship unloader and the forward and backward signals of the carriage are transmitted via the existing wireless communication devices (or newly installed optical fiber communications), with modifications made to the onboard configuration and program without affecting the original configuration.

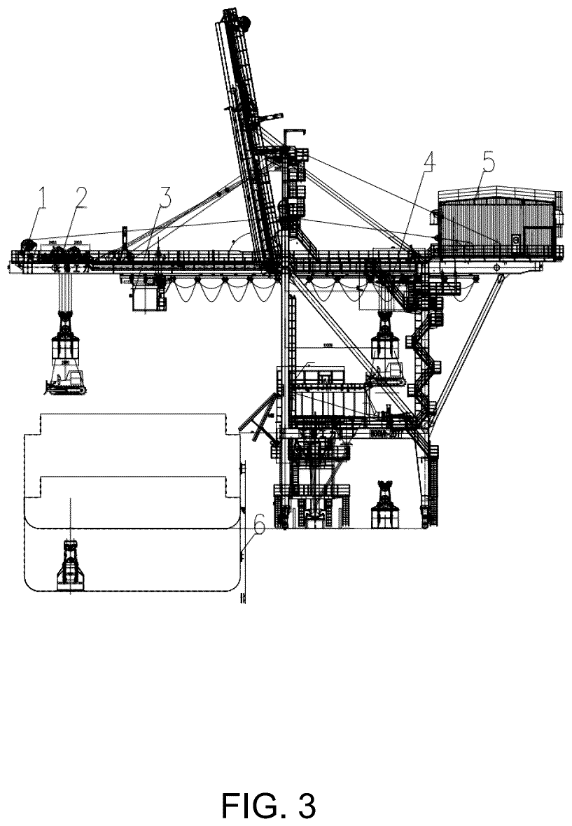

As shown in FIG. 3, the ship unloader is equipped with a beam 1, a trolley 2, a driver cabin 3, a grab bucket 4, and a machine room 5. This scheme additionally installs a reflector 6 at the bottom of the ship unloader.

The positional relationship between the driver cabin of the ship unloader and the antenna of the ship is affected by tidal changes and the weight of the ship itself, which influences the distance between the driver cabin and the antenna of the ship. On one hand, the tide gauge data can be pre-input into the PLC system; and on the other hand, based on tidal levels and ship draft conditions, a reflector can be installed on the hull. When the photoelectric limit sensor is activated, it is displayed to be within the normal operating interval, and when the photoelectric limit sensor does not sense the reflector, it is considered to be within the alarm interval. At this point, a signal to stop the movement of the carriage is output, prohibiting the carriage from entering the alarm zone to prevent collisions with cargo ships. Conversely, if the sense is normal, the ship unloader can pass safely.

Compared with the prior art, the present invention has the following advantages:

(1) The present invention installs the N photoelectric limit sensors, arranged at an interval of X meters, with the absolute encoder installed at the carriage position of each ship unloader; by connecting the photoelectric limit sensors and the absolute encoders into the PLC system of the ship unloader, the automatic calibration of the limit function is achieved; since there may be a slipping phenomenon between the carriage traveling wheels and tracks, the actual distance traveled by the absolute encoder between two limit sensors may be greater than X meters; the slipping phenomenon is corrected by the photoelectric limit sensors arranged at the equal interval; and the values of the absolute encoders can also be used to judge whether the photoelectric limit sensors are damaged.

Thus, the precise position of the ship unloader can be identified, enhancing the accuracy of the carriage movement of the ship unloader, improving operational safety of the equipment, reducing the operational risks of the equipment, and minimizes the possibility of major accidents.

(2) The photoelectric limit sensors have a low failure rate and can achieve the automatic validation function, making them a primary reliance for ensuring reliable system operations. However, the absolute encoders may occasionally provide inaccurate readings of distance. Therefore, it is necessary to design a self-validation circuit to reset the encoder values based on the actions of adjacent limit sensors, ensuring that the range of each zone consistently remains at X meters.

(3) Based on tide levels and ship draft conditions, tide gauge data can be pre-entered into the PLC system to dynamically update the alarm zone, thereby enhancing the reliability of the anti-collision system.

(4) This anti-collision system utilizes limit sensors to distinguish the terminal operational zones. Since domestic terminal port machinery has been upgraded to PLC and inverter control, logical circuits can be constructed through the onboard PLC. When the port machinery carriage reaches the limit zone, the alarm is triggered to remind the operator to pay attention to safety during operations. This design concept is characterized by high reliability, low cost (utilizing the existing PLC onboard), ease of maintenance, simple installation, etc.

The above describes in detail the preferred specific embodiments of the present invention. It should be understood that those skilled in the art can make numerous modifications and variations based on the concept of the present invention without creative labor. Therefore, any technical scheme obtained by those skilled in the art based on the concept of the present invention through logical analysis, reasoning, or limited experiments should fall within the protection scope determined by the claims.

What is claimed is:

1. A ship unloader anti-collision system based on PLC control, comprising:
a plurality of photoelectric limit sensors, evenly spaced in a terminal area to divide the terminal area into a plurality of zones;
an absolute encoder installed on a carriage part of a ship unloader to collect a forward distance of carriage traveling wheels;
a reflector installed on a hull to cooperate with the photoelectric limit sensors and trigger limit signals of the photoelectric limit sensors; and
a control unit connected to each photoelectric limit sensor and absolute encoder to determine an alarm zone requiring anti-collision according to incoming ship information in the terminal area; during movement of the ship unloader, receive the limit signals transmitted by each photoelectric limit sensor, calibrate the distance information generated by the absolute encoder, determine a position of the ship unloader, and real-time judge whether the position of the ship unloader reaches the alarm zone, and generate a collision alarm signal if reaching the alarm zone.

2. The ship unloader anti-collision system based on PLC control according to claim 1, wherein a process that the control unit calibrates the distance information generated by the absolute value encoder is specifically as follows:
when an Nth photoelectric limit sensor is triggered to generate the limit signal, i.e., entering an Nth zone, reading the forward distance information generated by the absolute encoder; during continuous movement of the ship unloader, judging whether the read forward distance information is less than n times spacing of the photoelectric limit sensors; if so, judging whether the limit signal generated by triggering a (N+1)th photoelectric limit sensor is received; if received, resetting a value of the absolute encoder to zero and determining a distance of the Nth zone as the spacing between the two photoelectric limit sensors; if the read forward distance information is greater than n times the spacing of the photoelectric limit sensors, judging that the (N+1)th photoelectric limit sensor is damaged, generating a damage alarm signal, and defaulting that the (N+1)th photoelectric limit sensor has been triggered and the distance of the Nth zone is the spacing between the two photoelectric limit sensors until the distance detected by the absolute encoder between two adjacent photoelectric limit sensors is less than n times the spacing of the photoelectric limit sensors, and then resetting the value of the absolute encoder to zero.

3. The ship unloader anti-collision system based on PLC control according to claim 2, wherein a value of n is 1.5.

4. The ship unloader anti-collision system based on PLC control according to claim 1, wherein the control unit determines the position of the ship unloader according to the value of the absolute encoder and the zone where the absolute encoder locates, thereby judging whether the position of the ship unloader has reached the alarm zone.

5. The ship unloader anti-collision system based on PLC control according to claim 4, wherein when a working region of the ship unloader overlaps with the alarm zone, the control unit issues an alarm signal for an anti-collision zone.

6. The ship unloader anti-collision system based on PLC control according to claim 1, wherein the control unit also obtains data from a tide gauge to dynamically adjust the alarm zone requiring anti-collision.

7. The ship unloader anti-collision system based on PLC control according to claim 1, wherein the alarm zone requiring anti-collision is determined according to a distance between an antenna of an incoming ship in the terminal area and a driver cabin of the ship unloader.

8. The ship unloader anti-collision system based on PLC control according to claim 1, wherein during the movement of the ship unloader, the control unit judges whether a photoelectric limit sensor at a corresponding position senses the reflector according to the forward distance transmitted by the absolute encoder and the limit signal from the photoelectric limit sensor, and if the reflector is sensed, the carriage is displayed to be in a normal operating interval; and if the reflector is not sensed, the carriage is judged to enter an alarm interval, and a signal to stop the movement of the carriage is output at the moment.

9. The ship unloader anti-collision system based on PLC control according to claim 1, wherein the reflector corresponds to a horizontal height of each photoelectric limit sensor and is located in the middle of the hull of the ship unloader.

10. The ship unloader anti-collision system based on PLC control according to claim 1, wherein the control unit is a PLC controller.
